(19) United States
(12) Patent Application Publication
(10) Pub. No.: US 2008/0285958 A1
(43) Pub. Date: Nov. 20, 2008

(54) STORAGE APPARATUS FOR DIGITAL/ANALOG TV AUDIO/VIDEO MEDIA

(75) Inventors: Wen-ming Huang, Dasi Township (TW); Ching-chun Huang, Taipei City (TW); Chi-wei Hsiao, Jhonghe City (TW); Wen-fu Tsai, Renwu Township (TW); Hsin-ching Yin, Gangshan Township (TW); Hsiang-chi Hsieh, Sindian City (TW); Yu-feng Lin, Mailiao Township (TW)

Correspondence Address: KIRTON AND MCCONKIE, 60 EAST SOUTH TEMPLE,, SUITE 1800, SALT LAKE CITY, UT, 84111, US

(73) Assignee: GENESYS LOGIC, INC., Shindian City (TW)

(21) Appl. No.: 12/120,376

(22) Filed: May 14, 2008

Related U.S. Application Data
(60) Provisional application No. 60/938,785, filed on May 18, 2007.

(51) Int. Cl. H04N 7/26

(52) U.S. Cl. 386/124

(57) ABSTRACT

Disclosed is a storage apparatus for digital TV video/analog TV video/digital audio broadcasting/analog audio broadcasting media (DTV/ATV/DAB/AAB). The storage apparatus comprises a controller, a DTV/ATV/DAB/AAB interface converter and at least one storage media interfaces. The controller has a plurality of terminals for controlling the storage apparatus. The DTV/ATV/DAB/AAB interface converter connects to one of the terminals and a digital/analog tuner to receive DTV/ATV/DAB/AAB signals and converts the DTV/ATV/DAB/AAB signals into DTV/ATV/DAB/AAB data. The storage media interfaces respectively connect to the terminals of the controller and to at least one portable storage media, for storing the DTV/ATV/DAB/AAB data received from the DTV/ATV/DAB/AAB interface converter into the portable storage media. The controller can be an OTG controller. Alternatively, the controller can be a USB host controller, accordingly, can be couple with an electronic device via a PCI EXPRESS/PCI interface converter for processing the DTV/ATV/DAB/AAB data by the electronic device.

### CROSS REFERENCE TO RELATED APPLICATION

This application claims the benefit of U.S. Provisional Patent Application Ser. No. 60/938,785, filed on May. 18, 2007.

### BACKGROUND OF THE INVENTION

1. Field of the Invention

The present invention relates to a storage apparatus for digital/analog TV audio/video (AV) media and, more particularly, to a storage apparatus capable of receiving, recording and playing digital/analog TV audio/video (AV) signals in multi-directional transmission ways and capable of connecting to an electronic apparatus with a PCI EXPRESS interface for further operation.

2. Description of Prior Art

The analog/digital TV (ATV/DTV) and analog/digital audio broadcasting (AAB/DAB) create a new era for home audiovisual entertainment. Especially, as DTV and DAB become popular, more channels are available for information and entertainment transmission to improve the life quality. However, the conventional DTV and DAB tend to provide one-way broadcasting in application, such as using digital set-top box to connect to high definition TV (HDTV) or digital stereo systems for high resolution audiovisual. There is a general lack of integrating multimedia applications, such as the on-the-fly recording (immediately recording) of DTV and DAB programs, editing and playing the stored DTV and DAB contents. This restricts applications of DTV and DAB.

In addition, the conventional portable multimedia storage and devices, such as flash memory, CD-R/W, DVD-R/W, hard disk drive, portable memory stick, digital camera, mobile phone, PDA, and et cetera, need to connect to a computer system for processing data conversion or multimedia decoding, editing and playing, then playing audio files or watching video files can be executed. The conventional audio or video players may be also limited to the playback of a medium. Therefore, such as aforesaid data conversion, decoding, editing and storing, a computer system cannot be omitted to perform the aforesaid job tasks. Therefore, a complete equipment of the computer system with the aforesaid portable multimedia storage devices undoubtedly is necessary.

However, data transmission loading of a PCI transmission interface usually become inadequate for processing large amount of multimedia data. This further restricts the connection and application between multimedia devices.

Several solutions have been proposed in various patents. For example, Taiwan Patent No. 515,200 disclosed a method and device for the set-top box for internal media format conversion and program downloading. The program interface has a complicated structure, which is expensive to build and difficult to use. Furthermore, the disclosed device does not provide on-the-fly recording while the user viewing the DTV or DAB program, which is a major disadvantage for DTV/DAB popularity.

U.S. Patent Publication No. 2004/0,264,929, titled “Information Storage Medium Storing Information for Generating DTV Stream, and Method and Apparatus for Converting DTV Stream”, disclosed a method to convert DVD audiovisual media format, such as MPEG-2 TS, MPEG-4 and MPEG-7, to DTV stream of DTV format for DTV broadcasting. The conversion method and structure are only for one-way data format conversion to provide DTV broadcasting. No functions are provided for DTV/DAB data conversion storage. Therefore, the disclosed method provides only a new source for DTV or DVB-H broadcasting, and little to the two-way application of DTV

Taiwan Patent No. 094211770 which belongs to the same applicants also fundamentally disclosed a structure for a storage medium for digital/analog TV and audio data.

### SUMMARY OF THE INVENTION

For overcoming the aforementioned drawbacks of the conventional technologies, the primary objective of the present invention is to provide a storage apparatus capable of receiving, storing, recording and playing and even editing digital/analog TV audio/video (AV) data in multi-directional data communication ways.

Another objective of the present invention is to provide a storage apparatus with a DTV/ATV/DAB/AAB interface converter, converting the DTV/ATV/DAB/AAB signals for storing the DTV/ATV/DAB/AAB data into at least one portable storage media. Furthermore, charging the portable storage media device which needs to be charged also can be executed in the meantime.

Yet another objective of the present invention is to provide a storage apparatus with a PCI EXPRESS interface connection for connecting an electronic device for processing DTV/ATV/DAB/AAB data converted from the DTV/ATV/DAB/AAB signals, such as compressing, filtering and format converting, and then, transmitting the signal to a plurality of storage media interfaces. The storage media interfaces are connected to portable storage devices, such as, a flash memory stick, a card reader, a CD-R/W, a DVD-R/W or a hard disk drive. The DTV/ATV, AAB, DAB data can be stored in these portable storage media and playback reversely later.

To achieve the aforementioned objectives, the present invention provides a storage apparatus for Digital TV Video/Analog TV Video/Digital Audio Broadcasting/Analog Audio Broadcasting media (DTV/ATV/DAB/AAB). The storage apparatus comprises a controller, a DTV/ATV/DAB/AAB interface converter and at least one storage media interfaces. The controller has a plurality of terminals for controlling the storage apparatus. The DTV/ATV/DAB/AAB interface converter connects to one of the terminals and a digital/analog tuner to receive DTV/ATV/DAB/AAB signals and converts the DTV/ATV/DAB/AAB signals into DTV/ATV/DAB/AAB data. The storage media interfaces respectively connect to the terminals of the controller and to at least one portable storage media, for storing the DTV/ATV/DAB/AAB data received from the DTV/ATV/DAB/AAB interface converter into the portable storage media. The controller can be an OTG controller. Alternatively, the controller can be a USB host controller, accordingly, USB host controller can couple with an electronic device via a PCI EXPRESS/PCI interface converter for processing the DTV/ATV/DAB/AAB data by the electronic device.

The DTV/ATV/DAB/AAB interface converter and a plurality of storage media interfaces are connected respectively to the terminals of the controller. As the controller can be a USB host controller, the electronic device coupled with the USB host controller can process the DTV/ATV/DAB/AAB data, such as compressing, filtering and format converting, and then downloads the processed DTV/ATV/DAB/AAB data to specific one of the portable storage media via the USB host controller and the corresponding storage media interfaces, so that, the DTV/ATV/DAB/AAB data can be stored in the portable storage media. The portable storage media can be a flash memory, a memory card, a CD-R/W, a DVD-R/W or a hard disk drive.

The advantage of the present invention is to enable playing, storing, and on-the-fly recording of the DTV/ATV/DAB/AAB data via a simple and inexpensive structure. With the present invention, the DTV/ATV/DAB/AAB data can be played as well as stored in portable storage devices, such as a flash memory, a CD-R/W, a DVD-R/W or a hard disk drive for various further applications.

### BRIEF DESCRIPTION OF THE DRAWINGS

FIG. 1 is a system block diagram of a first embodiment of the present invention;

FIG. 2 is a block diagram of the PCI EXPRESS/PCI interface converter of FIG. 1;

FIG. 3 is a system block diagram of a second embodiment of the present invention;

FIG. 4 is a system block diagram of a third embodiment of the present invention; and

FIG. 5 is a system block diagram of a fourth embodiment of the present invention.

### DETAILED DESCRIPTION OF THE INVENTION

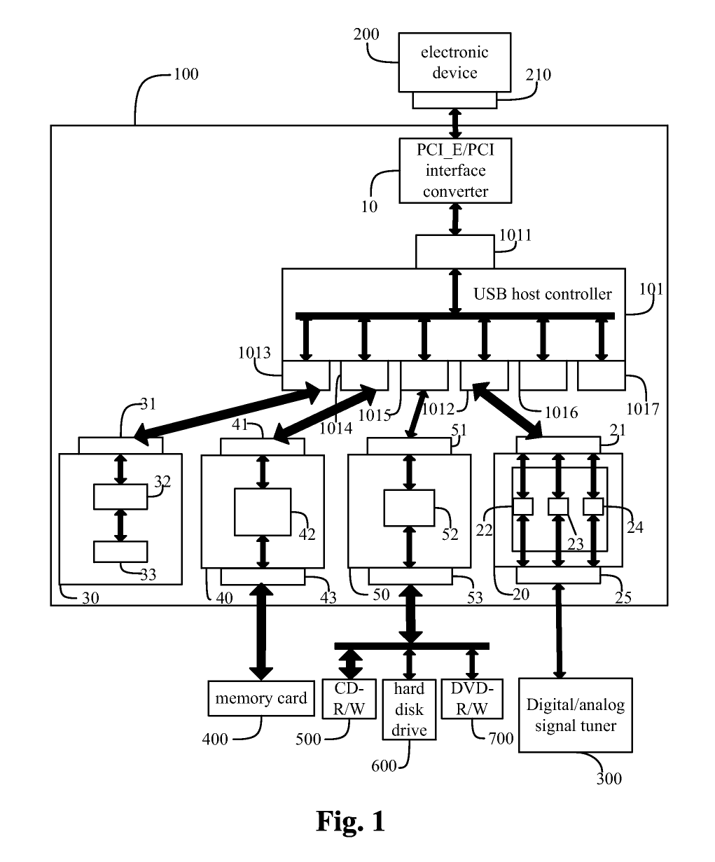

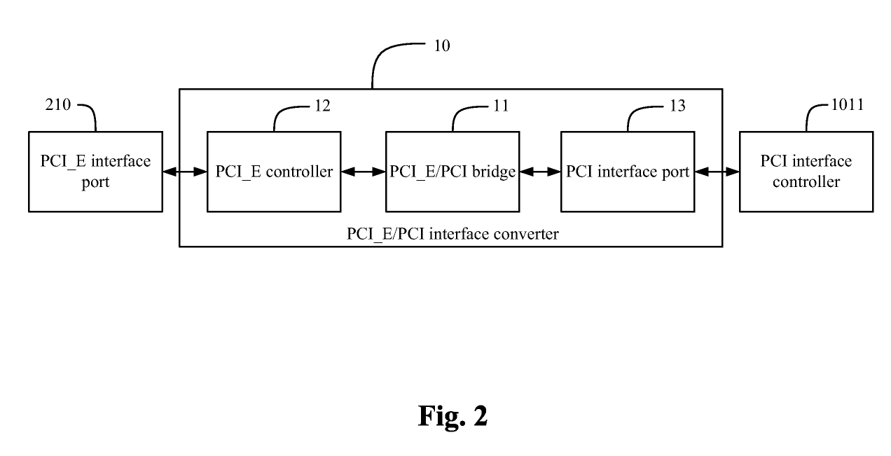

With reference to FIGS. 1 and 2, these show a first embodiment of DTV/ATV/DAB/AAB media storage apparatus with a PCI EXPRESS interface connection in accordance with the present invention. A DTV/ATV/DAB/AAB media storage apparatus 100 with a PCI EXPRESS interface connection includes at least a PCI EXPRESS/PCI interface converter 10, a USB host controller 101, a DTV/ATV/DAB/AAB interface converter 20 and a plurality of storage media interfaces 30, 40 and 50. The PCI EXPRESS/PCI interface converter 10 is connected to an electronic device 200 with a PCI EXPRESS interface. The PCI EXPRESS/PCI interface converter 10 provides data conversion between PCI EXPRESS interface and PCI interface. The PCI EXPRESS/PCI interface converter 10 is not limited to any specific type. The PCI EXPRESS/PCI interface converter 10 of the present embodiment includes a PCI EXPRESS/PCI bridge 11, a PCI EXPRESS controller 12, and a PCI interface terminal 13 as shown in FIG. 2. The PCI EXPRESS/PCI bridge 11 converts data between PCI EXPRESS and PCI interfaces. The PCI EXPRESS controller 12 and the PCI interface terminal 13 are connected respectively to two ends of the PCI EXPRESS/PCI bridge 11. The PCI EXPRESS controller 12 is also connected to a PCI EXPRESS interface terminal 210 of the electronic device 200 so that the PCI EXPRESS/PCI interface converter 10 and the electronic device 200 with a PCI EXPRESS interface form a two-way data communication.

The aforementioned USB host controller 101 provides the function of PCI/USB interface conversion and the function of the USB host controller or an OTG controller. The USB host controller 101 includes a PCI interface controller 1011 and a plurality of terminals 1012, 1013, 1014, 1015, 1016 and 1017. The PCI interface controller 1011 of the USB host controller 101 is connected to the PCI interface terminal 12 of the PCI EXPRESS/PCI interface converter 10 so as to form a two-way data communication between the PCI EXPRESS/PCI interface converter 10 and the USB host controller 101. Accordingly, a two-way data communication is formed and established between the USB host controller 101 and the electronic device 200 via the PCI EXPRESS/PCI interface converter 10. Alternatively, as aforementioned, the USB host controller 101 can also a role of an OTG controller to control the whole DTV/ATV/DAB/AAB media storage apparatus 100 in another embodiment.

The aforementioned DTV/ATV/DAB/AAB interface converter 20 may include a USB controller 21, a DTV signal processor 22, a DAB signal processor 23, an ATV signal processor 24, and an input signal interface 25. The USB controller 21 is connected to the terminal 1012 of the USB host controller 101 to provide a two-way USB-typed data connection between the DTV/ATV/DAB/AAB interface converter 20 and the USB host controller 101. The DTV signal processor 22 converts the DTV signal into DTV data with a suitable format for playing or editing on the electronic device 200 with a PCI EXPRESS interface. The DTV signal processor 22 is connected to the USB controller 21. The PCI interface controller 1011 of the USB host controller 101 can transmits the processed DTV data via the PCI EXPRESS/PCI interface converter 10 to the electronic device 200 for playing, editing or temporary storage.

The DAB signal processor 23 converts the DAB signal into DAB data with a suitable format for playing or editing on the electronic device 200 with a PCI EXPRESS interface. The DAB signal processor 23 is connected to the USB controller 21. The PCI interface controller 1011 of the USB host controller 101 can transmits the processed DAB data via the PCI EXPRESS/PCI interface converter 10 to the electronic device 200 for playing, editing or temporary storage.

The ATV signal processor 24 converts the ATV signal into ATV data with a suitable format for playing or editing on the electronic device 200 with a PCI EXPRESS interface. The ATV signal processor 24 is connected to the USB controller 21. The PCI interface controller 1011 of the USB host controller 101 can transmits the processed ATV data via the PCI EXPRESS/PCI interface converter 10 to the electronic device 200 for playing, editing or temporary storage.

Alternatively, an AAB signal processor similar to the DAB signal processor also can be illustrated. The AAB signal processor converts the AAB signal into AAB data with a suitable format for playing or editing on the electronic device 200 with a PCI EXPRESS interface. The AAB signal processor is connected to the USB controller 21. The PCI interface controller 1011 of the USB host controller 101 can transmits the processed AAB data via the PCI EXPRESS/PCI interface converter 10 to the electronic device 200 for playing, editing or temporary storage.

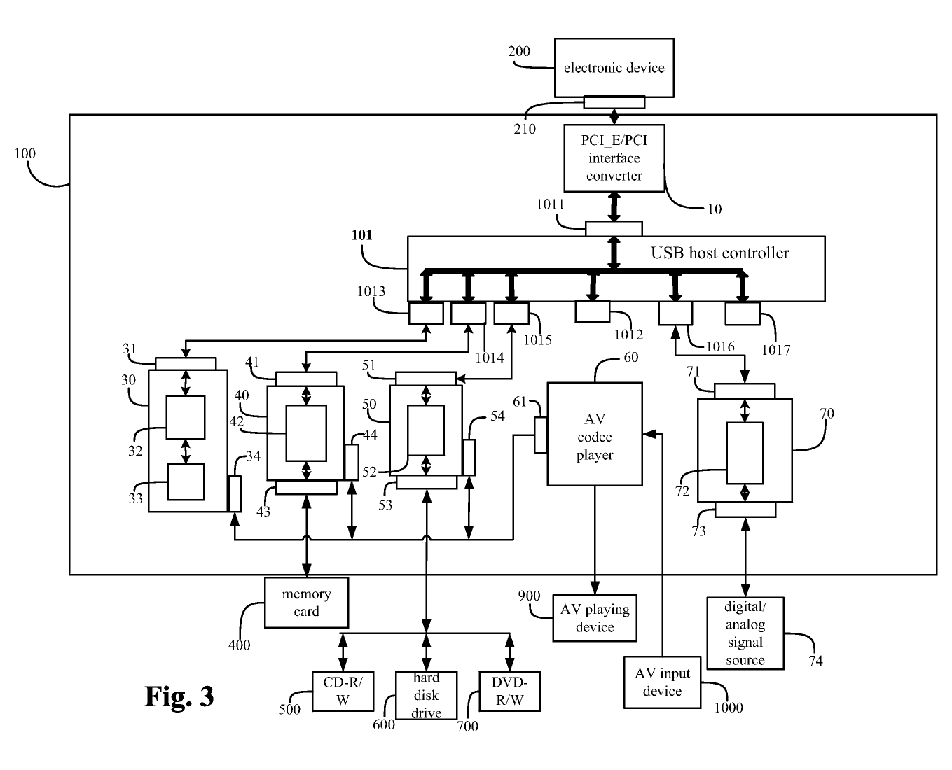

The aforementioned signal input interface 25 can be connected to an external digital/analog signal tuner 300. The Digital/analog signal tuner 300 is employed for receiving one of the DTV/ATV/DAB/AAB signals in the air. Alternatively, the Digital/analog signal tuner 300 can also be embedded into the DTV/ATV/DAB/AAB interface converter 20 as an integrated chipset. As mentioned in later embodiments, the digital/analog interface converter 70 shown in FIG. 3˜5 can directly receive DTV/ATV/DAB/AAB signals from the digital/analog signal source 74 without additional tuner. The signal input interface 25 is to multiplex the DTV/ATV/DAB/AAB signals. The signal input interface 25 is internally connected to the DTV signal processor 22, the DAB signal processor 23, and the ATV signal processor 24 to provide DTV/ATV/DAB/AAB signals to the DTV signal processor 22, the DAB signal processor 23, and the ATV signal processor 24 (An AAB signal processor also can be illustrated) for signal processing, respectively.

The aforementioned storage media interfaces 30, 40 and 50 are not limited to any specific type. In the present invention, the portable storage media, such as, a flash memory stick, a memory card, CD-R/W, DVD-R/W and a hard disk drive, are used as embodiment. Other equivalent portable storage media and corresponding storage media interfaces are also within the scope of the present invention. The storage media interface 30 includes a USB controller 31, a flash memory access controller 32, and at least a flash memory 33. The USB controller 31 is connected to a terminal 1013 of the USB host controller 101 to form a two-way USB-type data connection between the storage media interface 30 and the USB host controller 101. The flash memory access controller 32 can control the data access, and the flash memory 33 is controlled by the flash memory access controller 32. The flash memory 33 is not limited to any specific type. The present invention uses NAND FLASH or NOR FLASH as embodiment for explanation.

For example, if some DTV/ATV/DAB/AAB data has already been stored in the flash memory 33. The aforementioned flash memory access controller 32, connected to the USB controller 31 transmits the DTV/ATV/DAB/AAB data to the electronic device 200 via the USB host controller 101 and the PCI EXPRESS/PCI interface converter 10 for playing, processing or temporary storage. Alternatively, the DTV/ATV/DAB/AAB data can be processed, such as, compressing, filtering and format converting by the electronic device 200 after receiving from the DTV/ATV/DAB/AAB interface converter 20, and then the electronic device 200 can download the processed DTV/ATV/DAB/AAB data for storing in the flash memory 33.

The aforementioned storage media interface 40 includes a USB controller 41, a card reader controller 42 and a memory card connector 43. The USB controller 41 is connected to the terminal 1014 of the USB host controller 101 to form a two-way USB-type data connection between the storage media interface 40 and the USB host controller 101. The card reader controller 42 is to control the data access, and the memory card connector 43 is employed to connect to at least one memory card 400. The memory card 400 can be the CF/SD/MMC/XD/SM/MS/MSPRO/MS DUO, and et cetera. The memory card connector 43 is connected to the card reader controller 42 so that the memory card 400 can be controlled by the card reader controller 42 for data access. For example, if some DTV/ATV/DAB/AAB data has already been stored in the memory card 400. The card reader controller 42, connected to the USB controller 41 transmits the DTV/ATV/DAB/AAB data to the electronic device 200 via the USB host controller 101 and the PCI EXPRESS/PCI interface converter 10 for playing, processing or temporary storage. Alternatively, the DTV/ATV/DAB/AAB data can be processed, such as, compressing, filtering and format converting by the electronic device 200 after receiving from the DTV/ATV/DAB/AAB interface converter 20, and then the electronic device 200 can download the processed DTV/ATV/DAB/AAB data for storing in the memory card 400.

The aforementioned storage media interface 50 includes a USB controller 51, an ATA/ATAPI/SATA interface controller 52 and a plurality of interface connectors 53. The USB controller 51 is connected to the terminal 1015 of the USB host controller 101 to form a two-way USB-type data connection between the storage media interface 50 and the USB host controller 101. The ATA/ATAPI/SATA controller 52 is to control the data access of the ATA/ATAPI/SATA type interface, and the interface connectors 53 are employed to connect to a CD-R/W drive 500, a hard disk drive 600, or a DVD-R/W drive 700. The CD-R/W drive 500, the hard disk drive 600, and the DVD-R/W drive 700 may have an ATA/ATAPI/SATA type interface respectively. The interface connectors 53 are connected to the ATA/ATAPI/SATA controller 52 so that the CD-R/W drive 500, the hard disk drive 600, and the DVD-R/W drive 700 can be controlled by the ATA/ATAPI/SATA controller 52 for data access to the CD-R/W disc loaded in the CD-R/W drive 500, the hard disk drive 600 or the DVD-R/W disc loaded in the DVD-R/W drive 700.

For example, if some DTV/ATV/DAB/AAB data has already been stored in the CD-R/W disc loaded in the CD-R/W drive 500, the hard disk drive 600 or the DVD-R/W disc loaded in the DVD-R/W drive 700. The ATA/ATAPI/SATA controller 52, connected to the USB controller 51 transmits the DTV/ATV/DAB/AAB data to the electronic device 200, via the USB host controller 101 and the PCI EXPRESS/PCI interface converter 10 for playing, processing or temporary storage. Alternatively, the DTV/ATV/DAB/AAB data can be processed, such as, compressing, filtering and format converting by the electronic device 200 after receiving from the DTV/ATV/DAB/AAB interface converter 20, and then the electronic device 200 can download the processed DTV/ATV/DAB/AAB data for storing in the CD-R/W disc loaded in the CD-R/W drive 500, the hard disk drive 600 or the DVD-R/W disc loaded in the DVD-R/W drive 700, the storing for the CD-R/W disc or the DVD-R/W disc is also called burning.

In general, the USB host controller 101 controls the flash memory 33, the memory card 400, the CD-R/W drive 500, the hard disk drive 600 and the DVD-R/W drive 700 as USB devices through the storage media interfaces 30, 40, 50 and the digital/analog interface converter 70. The aforesaid terminals 1012, 1013, 1014, 1015, 1016 and 1017 are ports of the USB host controller 101. Alternatively, the storage media interfaces 30, 40, 50 are not limited to the individual circuit elements as shown in FIG. 1. The storage media interfaces 30, 40 and 50 and further the USB host controller 101 can be integrated into an IC or a circuit module. Accordingly, the plurality of internal interfaces such as, endpoints also can be illustrated for being the aforesaid terminals 1012, 1013, 1014, 1015, 1016 and 1017 respectively in circuit design. In this embodiment, the USB host controller 101 controls the flash memory 33, the memory card 400, the CD-R/W drive 500, the hard disk drive 600 and the DVD-R/W drive 700 as internal units in the IC or the circuit module but not USB devices.

The terminals 1012, 1013, 1014, 1015 of the USB host controller 101 provide connection to the DTV/ATV/DAB/AAB signal interface converter 20 and the storage media interfaces 30, 40, 50 so that the DTV/ATV/DAB/AAB signal interface converter 20 and the storage media interfaces 30, 40, 50 can form two-way data communication with the electronic device 200 via the USB host controller 101 and the PCI EXPRESS/PCI interface converter 10. In this way, objectives of storing the DTV/ATV/DAB/AAB data in the portable storage media and a PCI EXPRESS interface connection to an electronic device for receiving, storing, recording and playing and even editing the DTV/ATV/DAB/AAB data can be achieved.

FIG. 3 shows a second embodiment of the present invention. The storage media interface 30 includes a parallel/serial transmission interface 34, the storage media interface 40 includes a parallel/serial transmission interface 44, and the storage media interface 50 includes a parallel/serial transmission interface 54. An audio/video codec player 60 provides functions for encoding/decoding and playing audio/video data of all formats, including MP3, WMA, MIDI, WAV, and et cetera. The audio/video codec player 60 includes a parallel/serial transmission interface 61 for providing connection respectively to the parallel/serial transmission interface 34 of the storage media interface 30, the parallel/serial transmission interface 44 of the storage media interface 40, and the parallel/serial transmission interface 54 of the storage media interface 50 so that the audio/video codec player 60 forms two-way audio/video data communication with the storage media interfaces 30, 40 and 50.

The audio/video codec player 60 can be connected to an audio/video playing device 900 or an audio/video input device 1000. The audio/video playing device 900 is not limited to any specific type. The present invention uses the speaker as an embodiment for explanation. Other equivalent devices, such as earphone, moreover, a display or a TV for playing DTV/ATV/DAB/AAB data, are also within the scope of the present invention. The audio/video input device 1000 is not limited to any specific type, either. The present invention uses the microphone as an embodiment for explanation. The user's voice can be inputted from the microphone and recorded by audio/video codec player 60, such as using ADPCM format. Other equivalent devices, such as CD/VCD/DVD line-in and broadcasting audio/video line-in, are also within the scope of the present invention. The audio/video codec player 60 can employ the audio/video playing device 900 and the audio/video input device 1000 for playing and inputting audio/video data.

Through the two-way audio data communication formed between the audio/video codec player 60 and the storage media interfaces 30, 40 and 50, the audio/video data in the electronic device 200 can be transmitted via the PCI EXPRESS/PCI interface converter 10, the USB host controller 101 to and from the storage media interface 30, 40 and 50. Accordingly, the audio/video data and aforesaid DTV/ATV/DAB/AAB data can be decoded by the audio/video codec player 60 and played on the audio/video playing device 900. Alternatively, the digital or analog audio/video data from the audio/video input device 100 can be encoded by the audio/video codec player 60, and transmitted via the storage media interfaces 30, 40, 50, the USB host controller 101, and the PCI EXPRESS/PCI interface converter 10 to the electronic device 200 for playing, processing or temporary storage.

As shown in FIG. 3, a terminal 1016 of the USB host controller 101 is connected to a digital/analog interface converter 70 (such as DTV/ATV/DAB/AAB converter). The digital/analog interface converter 70 includes a USB controller 71, a digital/analog signal processor 72, and a digital/analog signal input interface 73. The USB controller 71 is connected to the terminal 1016 of the USB host controller 101. The digital/analog signal processor 72 is connected to the USB controller 71. The digital/analog signal processor 72 converts the digital/analog audio/video data into a format that can be suitable for playing, processing or editing at the electronic device 200. The digital/analog signal input interface 73 provides connection to at least a digital/analog signal source 74, such as DTV, ATV, DAB or AAB in the air so that the DTV/ATV/DAB/AAB signals can be inputted to the digital/analog signal input interface 73, and can be processed by the digital/analog signal processor 72, such as being converted into DTV/ATV/DAB/AAB data. The processed DTV/ATV/DAB/AAB data are transmitted via the USB controller 71, the PCI interface controller 1011 of the USB host controller 101, and the PCI EXPRESS/PCI interface converter 10 to the electronic device 200 for playing , processing or temporary storage.

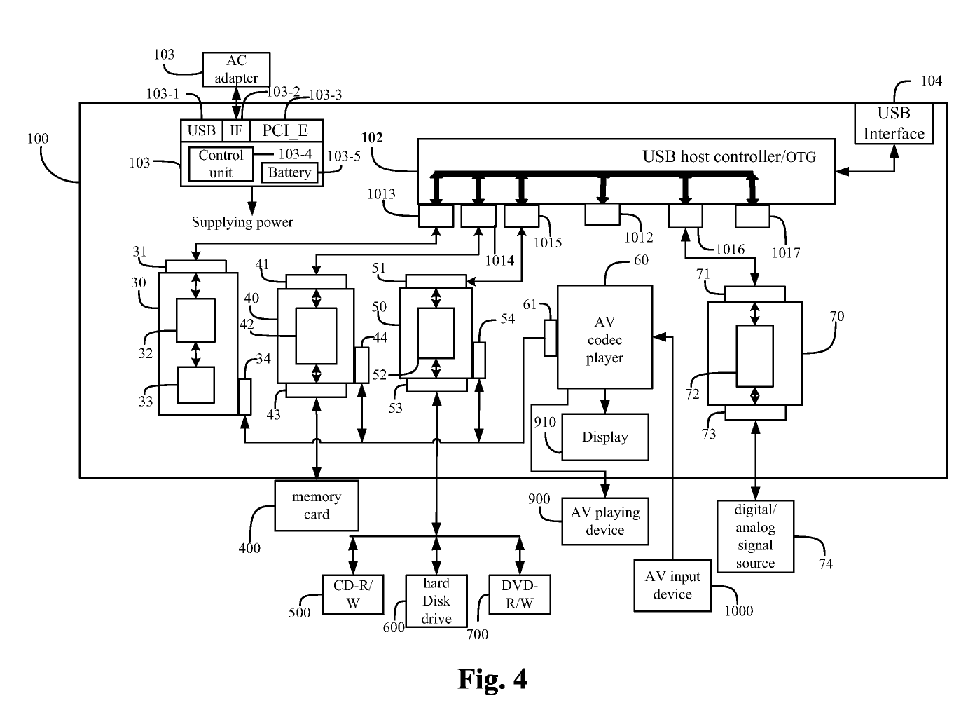

FIG. 4 shows a third embodiment of the present invention. Similarly as aforementioned related with FIG. 1 and FIG. 3, in this embodiment, the controller of the storage apparatus 100 is an OTG (on the GO) controller 102. Similarly, the controller also can be an USB host controller as aforementioned. The storage apparatus 100 also can include a USB interface 104 to link the OTG controller 102 or the aforesaid USB host controller to an electronic device as being a simple storage. The storage apparatus 100 can process the DTV/ATV/DAB/AAB data without the electronic device 200 shown in FIG. 1 and FIG. 3. The OTG controller 102 can store the DTV/ATV/DAB/AAB data into the flash memory 33, the portable storage media 400, 500, 600 or 700 via the storage media interfaces 30, 40 and 50. Reversely, the OTG controller 102 can access the flash memory 33, the portable storage media 400, 500, 600 and 700 to play the DTV/ATV/DAB/AAB data stored therein by employing the audio/video codec player 60. Similarly, the OTG controller 102 can operate the audio/video codec player 60 to employ the audio/video playing device 900 and the audio/video input device 1000 for playing and inputting audio/video data. Moreover, the storage apparatus 100 can further include a display 910 to be employed by the audio/video codec player 60 for playing audio/video data instead of the audio/video playing device 900 connected additionally.

Furthermore, the storage apparatus 100 may further include a charging system 103 which can provides electric power for OTG controller 102 to control the whole storage apparatus 100. The electric power can be supplied from a USB interface 103-1, an interface connected to an AC adapter 105 or a PCI EXPRESS 103-3 connected to the PCI EXPRESS/PCI interface converter 10 in FIG. 1. Furthermore, the charging system 103 further includes a control unit 103-4 for controlling the charging system 103 and a battery 103-5 for saving the electric power. Moreover, once one of the portable storage media 400, 500, 600, 700, the audio/video playing device 900 and the audio/video input device 1000 is a portable device which may need to be charged, the aforesaid portable device can be charged by employing the electric power from the charging system 103 and can be accessed in the meantime by the OTG controller 102.

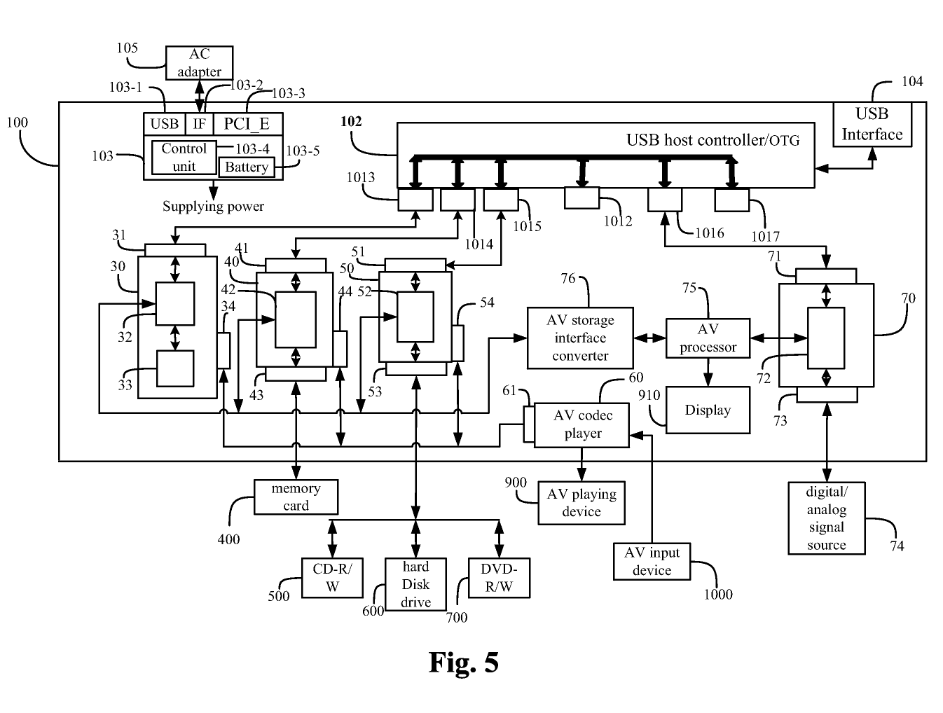

FIG. 5 shows a fourth embodiment of the present invention. In this embodiment, the storage apparatus 100 can further comprises an audio/video processor 75 and an audio/video storage interface converter 76. The audio/video processor 75 is connected to digital/analog signal processor 72 of the digital/analog interface converter 70 directly. The audio/video storage interface converter 76 is connected to the audio/video processor 75 and to the flash memory access controller 32, the card reader controller 42 and the ATA/ATAPI/SATA interface controller 52. In the other words, the digital/analog data (such as DTV/ATV/DAB/AAB data) from the digital/analog interface converter 70 (such as DTV/ATV/DAB/AAB converter) can be stored into the portable storage media 400, 500, 600, 700 directly without being processed by the OTG controller 102 so that the process loading of the OTG controller 102 can be decreased if necessary. Moreover, the audio/video processor 75 is coupled to a display 910 directly to allow the user to enjoy audio/video files of the DTV/ATV/DAB/AAB data received from the digital/analog interface converter 70 Furthermore, the audio/video processor 75, the audio/video storage interface converter 76 and the display 910 also can be employed in first and second embodiments of the present invention for providing more capability of processing the DTV/ATV/DAB/AAB data according to the present invention.

As is understood by a person skilled in the art, the foregoing preferred embodiments of the present invention are illustrative rather than limiting of the present invention. It is intended that they cover various modifications and similar arrangements be included within the spirit and scope of the appended claims, the scope of which should be accorded the broadest interpretation so as to encompass all such modifications and similar structure.

What is claimed is:

1. A storage apparatus for Digital TV Video/Analog TV Video/Digital Audio Broadcasting/Analog Audio Broadcasting media (DTV/ATV/DAB/AAB), comprising:
a controller, having a plurality of terminals for controlling the storage apparatus;
a DTV/ATV/DAB/AAB interface converter, connected to one of the terminals and a digital/analog tuner, receiving DTV/ATV/DAB/AAB signals from the digital/analog tuner and converting the DTV/ATV/DAB/AAB signals into DTV/ATV/DAB/AAB data; and
at least one storage media interfaces, respectively connected to the terminals and at least one portable storage media, for storing the DTV/ATV/DAB/AAB data received from the DTV/ATV/DAB/AAB interface converter into the portable storage media.

2. The storage apparatus according to claim 1, further comprising an audio/video processor, processing the DTV/ATV/DAB/AAB data directly received from the DTV/ATV/DAB/AAB interface converter.

3. The storage apparatus according to claim 2, further comprising an audio/video storage interface converter to transmit the processed DTV/ATV/DAB/AAB data from the audio/video processor for storing the processed DTV/ATV/DAB/AAB data into the portable storage media.

4. The storage apparatus according to claim 2, further comprising a display, coupled to the audio/video processor to play video files of the DTV/ATV/DAB/AAB data.

5. The storage apparatus according to claim 1, wherein the DTV/ATV/DAB/AAB interface converter further comprises:
a terminal, connected to one of the terminals of the controller;
a signal input interface, connected to the digital/analog tuner for transmitting DTV/ATV/DAB/AAB signals received by the digital/analog tuner; and
a signal processor, connected to the signal input interface and the controller for converting the DTV/ATV/DAB/AAB signals into the DTV/ATV/DAB/AAB data to the controller.

6. The storage apparatus according to claim 5, wherein the signal input interface can transmit a DTV signal, an ATV signal, a DAB signal, or an AAB signal received by the digital/analog tuner to the signal processor.

7. The storage apparatus according to claim 1, wherein the storage media interface comprises a flash memory interface for storing the DTV/ATV/DAB/AAB data in a flash memory as being the portable storage media.

8. The storage apparatus according to claim 7, wherein the flash memory interface further comprises:
a flash memory terminal, connected to one of the terminals of the controller; and
a flash memory access controller, connected to the flash memory terminal for accessing to the flash memory.

9. The storage apparatus according to claim 1, wherein the storage media interface comprises a card reader portable interface for storing the DTV/ATV/DAB/AAB data in a memory card as being the portable storage media.

10. The storage apparatus according to claim 9, wherein the card reader portable interface further comprises:
a card reader terminal, connected to one of the terminals of the controller;
a memory card connector for connecting to the memory card; and
a card reader controller, connected to the card reader terminal for accessing to the memory card via the memory card connector.

11. The storage apparatus according to claim 1, wherein the storage media interface comprises a portable ATA/ATAPI/SATA interface for storing the DTV/ATV/DAB/AAB data in an ATA/ATAPI/SATA-interfaced storage media as being the portable storage media.

12. The storage apparatus according to claim 11, wherein the portable ATA/ATAPI/SATA interface further comprises:
a ATA/ATAPI/SATA-interfaced terminal, connected to one of the terminals of the controller;
a plurality of interface connectors for connecting to the ATA/ATAPI/SATA-interfaced storage media; and
an ATA/ATAPI/SATA interface controller, connected to the USB controller for accessing the ATA/ATAPI/SATA-interfaced storage media via the portable ATA/ATAPI/SATA interface.

13. The storage apparatus according to claim 1, wherein the storage media interfaces are connected to an audio/video codec player.

14. The storage apparatus according to claim 13, wherein the audio/video codec player is connected to an audio/video playing device to play audio/video data received from the audio/video playing device.

15. The storage apparatus according to claim 13, wherein the audio/video codec player is connected to an audio/video signal input device to play the DTV/ATV/DAB/AAB data stored in the portable storage media by the audio/video signal input device.

16. The storage apparatus according to claim 13, further comprising a display, coupled to the audio/video codec player to play the DTV/ATV/DAB/AAB data stored in the portable storage media.

17. The storage apparatus according to claim 1, further comprising a Charging system, supplying electric power to the storage apparatus.

18. The storage apparatus according to claim 17, wherein the charging system further comprises a control unit for controlling the charging system.

19. The storage apparatus according to claim 17, wherein the charging system further comprises a battery for saving the electric power.

20. The storage apparatus according to claim 17, wherein the charging system further comprises a USB interface to couple to an electronic device for supplying the electric power to the storage apparatus.

21. The storage apparatus according to claim 17, wherein the charging system further comprises an interface to couple to an AC adapter for supplying the electric power to the storage apparatus.

22. The storage apparatus according to claim 17, wherein the charging system further comprises a PCI EXPRESS interface to couple to an electronic device for supplying the electric power to the storage apparatus.

23. The storage apparatus according to claim 1, further comprising a Charging system, supplying electric power to charge the portable storage media which needs to be charged.

24. The storage apparatus according to claim 1, wherein the controller is an OTG controller.

25. The storage apparatus according to claim 1, wherein the controller is a USB host controller.

26. The storage apparatus according to claim 25, wherein the terminals are ports of the USB host controller and the portable storage media are controlled are USB devices controlled by the USB host controller.

27. The storage apparatus according to claim 25, wherein the terminals are internal interfaces of an integrated circuit integrating the USB host controller and the portable storage media.

28. The storage apparatus according to claim 25, further comprising a PCI EXPRESS/PCI interface converter, connected to a PCI interface controller of the USB host controller and a PCI EXPRESS interface of an electronic device.

29. The storage apparatus according to claim 28, wherein the PCI EXPRESS/PCI interface converter further comprises:
a PCI EXPRESS/PCI bridge, providing data conversion between the PCI EXPRESS interface and the PCI interface controller;
a PCI interface terminal, connecting the PCI interface controller and the PCI EXPRESS/PCI bridge; and
a PCI EXPRESS controller, connecting the PCI EXPRESS/PCI bridge and the PCI EXPRESS interface of the electronic device.

30. A storage apparatus for storage apparatus for Digital TV Video/Analog TV Video/Digital Audio Broadcasting/Analog Audio Broadcasting media (DTV/ATV/DAB/AAB), comprising:
a USB host controller, having a PCI interface controller and a plurality of USB interfaces for controlling the storage apparatus;
a PCI EXPRESS/PCI interface converter, connected to the USB host controller via the PCI interface controller and connected to a PCI EXPRESS interface of an electronic device;
a DTV/ATV/DAB/AAB interface converter, connected to one of the USB interfaces and a digital/analog tuner to receive DTV/ATV/DAB/AAB signals from the digital/analog tuner, converting the DTV/ATV/DAB/AAB signals into DTV/ATV/DAB/AAB data; and
at least one storage media interfaces, respectively connected to the USB interfaces and connected respectively to at least one portable storage media, for storing the DTV/ATV/DAB/AAB data received from the DTV/ATV/DAB/AAB interface converter into the portable storage media.

31. The storage apparatus according to claim 30, wherein the electronic device processes the DTV/ATV/DAB/AAB data received from the DTV/ATV/DAB/AAB interface converter.

32. The storage apparatus according to claim 30, wherein the electronic device stores the DTV/ATV/DAB/AAB data into the portable storage media via the storage media interface.
